(19) United States
(12) Patent Application Publication
(10) Pub. No.: US 2026/0197735 A1
(43) Pub. Date: Jul. 9, 2026

(54) METHOD AND APPARATUS FOR IAB NODE MIGRATION

(71) Applicant: LENOVO (BEIJING) LIMITED, Beijing (CN)

(72) Inventors: Yibin ZHUO, Shanghai (CN); Mingzeng DAI, Shanghai (CN); Lianhai WU, Beijing (CN); Le YAN, Shanghai (CN)

(21) Appl. No.: 19/134,018

(22) PCT Filed: Jan. 13, 2023
(86) PCT No.: PCT/CN2023/072072

§ 371 Date: May 29, 2025

(51) Int. Cl. H04W 36/08

(52) U.S. Cl. CPC H04W 36/08

(57) ABSTRACT

Embodiments of the present disclosure relate to method and apparatus for integrated access and backhaul (IAB) node migration. According to some embodiments of the disclosure, a base station (BS) may: determine whether there is an internet protocol (IP) connection between a second BS and a third BS, wherein one of the first BS and the second BS has a radio resource control (RRC) connection to a mobile termination (MT) of a wireless network node and the other one of the first BS and the second BS has an F1 connection to a distributed unit (DU) of the wireless network node; and initiate, based on the determination, a migration of the MT of the wireless network node to the third BS or a migration of the DU of the wireless network node to the third BS.

### TECHNICAL FIELD

Embodiments of the present disclosure generally relate to communication technology, and more particularly to integrated access and backhaul (IAB) node migration.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

To extend the coverage and availability of wireless communication systems (e.g., 5G systems), the 3rd generation partnership project (3GPP) is envisioning integrated access and backhaul (IAB) architecture for supporting multi-hop relays. In an IAB network, an IAB node may hop through one or more IAB nodes before reaching a base station (also referred to as “an IAB donor” or “a donor node”). A single hop may be considered a special instance of multiple hops. Multi-hop backhauling is beneficial because it provides a relatively greater coverage extension compared to single-hop backhauling. In a relatively high frequency radio communication system (e.g., radio signals transmitted in frequency bands over 6 GHz), relatively narrow or less signal coverage may benefit from multi-hop backhauling techniques.

The industry desires technologies for facilitating communications in the IAB network.

### SUMMARY

Some embodiments of the present disclosure provide a first base station (BS). The first BS may include a transceiver; and a processor coupled to the transceiver. The processor may be configured to: determine whether there is an internet protocol (IP) connection between a second BS and a third BS, wherein one of the first BS and the second BS has a radio resource control (RRC) connection to a mobile termination (MT) of a wireless network node and the other one of the first BS and the second BS has an F1 connection to a distributed unit (DU) of the wireless network node; and initiate, based on the determination, a migration of the MT of the wireless network node to the third BS or a migration of the DU of the wireless network node to the third BS.

Some embodiments of the present disclosure provide a second BS. The second BS may include a processor; and a transceiver coupled to the processor. The transceiver may be configured to: receive, from a first BS, second information regarding IP connectivity to the first BS, or an inquiry about IP connectivity of the second BS, wherein one of the first BS and the second BS has an RRC connection to an MT of a wireless network node and the other one of the first BS and the second BS has an F1 connection to a DU of the wireless network node; and transmit, to the first BS, first information regarding IP connectivity to the second BS.

In some embodiments of the present disclosure, the first information includes a first list of BSs and each BS in the first list of BSs has an IP connection to the second BS. In some embodiments of the present disclosure, the second information includes a second list of BSs and each BS in the second list of BSs has an IP connection to the first BS.

Some embodiments of the present disclosure provide a third BS. The third BS may include a processor; and a transceiver coupled to the processor. The transceiver may be configured to: receive, from a first BS, an inquiry about whether there is an IP connection between the third BS and a second BS, wherein one of the first BS and the second BS has an RRC connection to an MT of a wireless network node and the other one of the first BS and the second BS has an F1 connection to a DU of the wireless network node; and transmit, to the first BS, a response to the inquiry.

In some embodiments of the present disclosure, in response to the response indicating that there is an IP connection between the third BS and the second BS, the transceiver is further configured to: receive, from the one of the first BS and the second BS, a request to migrate the MT of the wireless network node to the third BS; or receive, from the other one of the first BS and the second BS or the wireless network node, a request to migrate the DU of the wireless network node to the third BS.

Some embodiments of the present disclosure provide a first BS. The first BS may include a processor; and a transceiver coupled to the processor. The transceiver may be configured to: transmit a request to a third BS to migrate one of an MT and a DU of a wireless network node to the third BS, wherein the first BS connects to the one of the MT and DU of the wireless network node and the request comprises information associated with a second BS which connects to the other one of the MT and DU of the wireless network node; and receive a response to the request from the third BS.

In some embodiments of the present disclosure, the response indicates that the migration is refused due to no IP connection between the second BS and the third BS.

In some embodiments of the present disclosure, the information associated with the second BS includes an identifier of the second BS.

Some embodiments of the present disclosure provide a wireless network node. The wireless network node may include a processor; and a transceiver coupled to the processor. The transceiver may be configured to: transmit a request to a third BS to trigger a migration of a DU of the wireless network node from a first BS to the third BS, wherein an MT of the wireless network node has an RRC connection to a second BS; and receive a response in response to the request.

Some embodiments of the present disclosure provide a method performed by a first BS. The method may include: determining whether there is an IP connection between a second BS and a third BS, wherein one of the first BS and the second BS has an RRC connection to an MT of a wireless network node and the other one of the first BS and the second BS has an F1 connection to a DU of the wireless network node; and initiating, based on the determination, a migration of the MT of the wireless network node to the third BS or a migration of the DU of the wireless network node to the third BS.

Some embodiments of the present disclosure provide a method performed by a second BS. The method may include: receiving, from a first BS, second information regarding IP connectivity to the first BS, or an inquiry about IP connectivity of the second BS, wherein one of the first BS and the second BS has an RRC connection to an MT of a wireless network node and the other one of the first BS and the second BS has an F1 connection to a DU of the wireless network node; and transmitting, to the first BS, first information regarding IP connectivity to the second BS.

Some embodiments of the present disclosure provide a method performed by a third BS. The method may include: receiving, from a first BS, an inquiry about whether there is an IP connection between the third BS and a second BS, wherein one of the first BS and the second BS has an RRC connection to an MT of a wireless network node and the other one of the first BS and the second BS has an F1 connection to a DU of the wireless network node; and transmitting, to the first BS, a response to the inquiry.

Some embodiments of the present disclosure provide a method performed by a first BS. The method may include: transmitting a request to a third BS to migrate one of an MT and a DU of a wireless network node to the third BS, wherein the first BS connects to the one of the MT and DU of the wireless network node and the request comprises information associated with a second BS which connects to the other one of the MT and DU of the wireless network node; and receiving a response to the request from the third BS.

Some embodiments of the present disclosure provide a method performed by a wireless network node. The method may include: transmitting a request to a third BS to trigger a migration of a DU of the wireless network node from a first BS to the third BS, wherein an MT of the wireless network node has an RRC connection to a second BS; and receiving a response in response to the request.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions to facilitate and improve the implementation of various communication technologies, such as 5G NR.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate example block diagrams of a protocol stack for an IAB network in accordance with some embodiments of the present disclosure;

FIGS. 4 and 5 illustrate schematic diagrams of IAB node migration in accordance with some embodiments of the present disclosure;

FIGS. 6-16 illustrate flow charts of exemplary procedures of wireless communications in accordance with some embodiments of the present disclosure; and

FIG. 17 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architectures and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

Compared with the 4G communication system, the 5G communication system has raised more stringent requirements for various network performance indicators, for example, a 1000-time capacity increase, wider coverage requirements, ultra-high reliability, ultra-low latency, etc. Considering the rich frequency resources of high-frequency carriers, the use of high-frequency small station deployments is becoming more and more popular in hotspot areas in order to meet the needs of 5G ultra-high capacity. However, high-frequency carriers have poor propagation characteristics, severe attenuation due to obstructions, and limited coverage. Therefore, the dense deployment of small stations is required. In addition, the deployment of optical fiber may be difficult and costly for these small stations. Therefore, an economical and convenient backhaul scheme is needed. Integrated access and backhaul (LAB) technology, whose access link(s) and backhaul link(s) may both use wireless transmission solutions to avoid fiber deployment, provides ideas for solving the above problems.

In an IAB network, a wireless network node such as a relay node (RN) or an IAB node or a wireless backhaul node/device can provide wireless access services for UEs. For example, a UE can connect to an IAB donor relayed by one or more IAB nodes. The IAB donor may also be called a donor node or a donor base station (e.g., DgNB, Donor gNodeB). In addition, the wireless link between an IAB donor and an IAB node, or the wireless link between different IAB nodes can be referred to as a “backhaul link.” The wireless network node in an IAB network may be stationary or mobile. Embodiments of the present disclosure can be applied to the wireless network node regardless of whether it is stationary or mobile.

An IAB node may include an IAB mobile terminal (MT) part and an IAB distributed unit (DU) part. When an IAB node connects to its parent node (which may be another IAB node or an IAB donor), it can be regarded as a UE, i.e., the role of an MT. When an IAB node provides service to its child node (which may be another IAB node or a UE), it can be regarded as a network device, i.e., the role of a DU.

An IAB donor can be an access network element with a complete base station function, or an access network element with a separate form of a centralized unit (CU) and a distributed unit (DU). The IAB donor may be connected to the core network (for example, connected to the 5G core (5GC) network), and provide the wireless backhaul function for the IAB nodes. The CU of an IAB donor may be referred to as an “IAB donor-CU” (or directly referred to as a “CU”), and the DU of the IAB donor may be referred to as an “IAB donor-DU.” The IAB donor-CU may be separated into a control plane (CP) and a user plane (UP). For example, a CU may include one CU-CP and one or more CU-UPs.

Considering the limited coverage of a high frequency band, and in order to ensure coverage performance of the network, multi-hop networking may be adopted in an IAB network. Taking into account the requirements of service transmission reliability, IAB nodes can support dual connectivity (DC) or multi-connectivity to improve the transmission reliability, so as to deal with abnormal situations that may occur on the backhaul (BH) link, such as radio link failure (RLF) or blockage, load fluctuations, etc.

In the case where an IAB network supports multi-hop and dual-connection networking, there may be multiple transmission paths between the UE and the IAB donor. A transmission path may include multiple nodes, such as a UE, one or more IAB nodes, and an IAB donor (if the IAB donor is in the form of a separate CU and DU, it may also contain an IAB donor-DU and an IAB donor-CU). Each IAB node may treat the neighboring node that provides backhaul services for it as a parent node (or parent IAB node), and each IAB node can be regarded as a child node (or child IAB node) of its parent node.

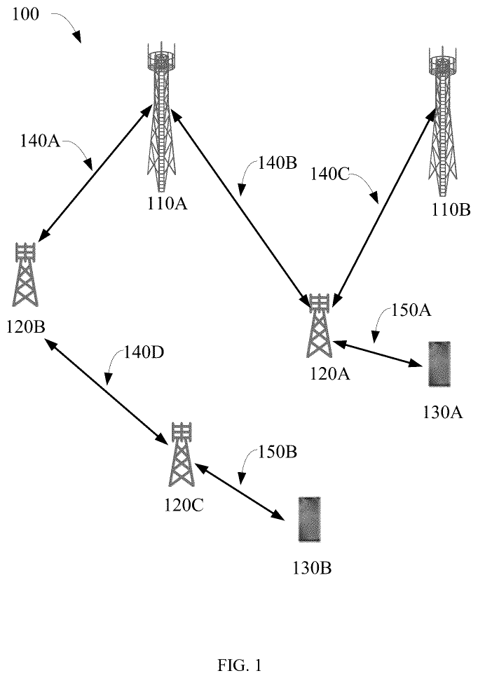

FIG. 1 illustrates a schematic diagram of wireless communication system 100 in accordance with some embodiments of the present disclosure.

As shown in FIG. 1, the wireless communication system 100 may include some base stations (e.g., IAB donor 110A and IAB donor 110B), some IAB nodes (e.g., IAB node 120A, IAB node 120B, and IAB node 120C), and some UEs (e.g., UE 130A and UE 130B). Although a specific number of UEs, IAB nodes, and IAB donors is depicted in FIG. 1, it is contemplated that any number of UEs, IAB nodes, and IAB donors may be included in the wireless communication system 100.

Each of IAB donor 110A, IAB donor 110B, IAB node 120A, IAB node 120B, and IAB node 120C may be directly connected to one or more IAB node(s) in accordance with some other embodiments of the present disclosure. Each of IAB donor 110A, IAB donor 110B, IAB node 120A, IAB node 120B, and IAB node 120C may be directly connected to one or more UEs in accordance with some other embodiments of the present disclosure.

UE 130A and UE 130B may be any type of device configured to operate and/or communicate in a wireless environment. For example, UE 130A and UE 130B may include a computing device, such as a desktop computer, a laptop computer, a personal digital assistant (PDA), a tablet computer, a smart television (e.g., television connected to the Internet), a set-top box, a game console, a security system (including a security camera), a vehicle on-board computer, a network device (e.g., router, switch, and modem), or the like. According to some embodiments of the present disclosure, UE 130A and UE 130B may include a portable wireless communication device, a smart phone, a cellular telephone, a flip phone, a device having a subscriber identity module, a personal computer, a selective call receiver, or any other device that is capable of transmission and receiving communication signals on a wireless network.

In some embodiments of the present disclosure, UE 130A and UE 130B may include wearable devices, such as smart watches, fitness bands, optical head-mounted displays, internet-of-things (IoT) devices, or the like. Moreover, UE 130A and UE 130B may be referred to as a subscriber unit, a mobile, a mobile station, a user, a terminal, a mobile terminal, a wireless terminal, a fixed terminal, a subscriber station, a user terminal, or a device, or described using other terminology used in the art.

IAB donors 110A and 110B may be in communication with a core network (not shown in FIG. 1). The core network (CN) may include a plurality of core network components, such as a mobility management entity (MME) (not shown in FIG. 1) or an access and mobility management function (AMF) (not shown in FIG. 1). The CNs may serve as gateways for the UEs to access a public switched telephone network (PSTN) and/or other networks (not shown in FIG. 1).

Wireless communication system 100 may be compatible with any type of network that is capable of transmitting and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, IAB donors 110A and 110B may transmit data using an orthogonal frequency division multiple (OFDM) modulation scheme on the DL. UE 130A and UE 130B may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

Persons skilled in the art should understand that as technology develops and advances, the terminologies described in the present disclosure may change, but should not affect or limit the principles and spirit of the present disclosure.

Referring to FIG. 1, IAB node 120A can be directly connected to IAB donors 110A and 110B, and IAB node 120B can be directly connected to IAB donor 110A. IAB donors 110A and 110B are parent nodes of IAB node 120A, and IAB donor 110A is a parent node of IAB node 120B. In other words, IAB nodes 120A and 120B are child IAB nodes of IAB donor 110A, and IAB node 120A is also a child IAB node of IAB donor 110B. IAB node 120C can reach IAB donor 110A by hopping through IAB node 120B. IAB node 120B is a parent IAB node of IAB node 120C. In other words, IAB node 120C is a child IAB node of IAB node 120B.

In some other embodiments of the present disclosure, an IAB node may be connected to IAB node 120C so it can reach IAB donor 110A by hopping through IAB node 120C and IAB node 120B. This IAB node and IAB node 120C may be referred to as the descendant IAB nodes of IAB node 120B.

UEs 130A and 130B can be connected to IAB nodes 120A and 120C, respectively. IAB nodes 120A and 120C may therefore be referred to as an access IAB node. Uplink (UL) packets (e.g., data or signaling) from UE 130A or UE 130B can be transmitted to an IAB donor (e.g., IAB donor 110A or 110B) via one or more IAB nodes, and then transmitted by the IAB donor to a mobile gateway device (such as the user plane function (UPF) in the 5GC). Downlink (DL) packets (e.g., data or signaling) can be transmitted from the IAB donor (e.g., IAB donor 110A or 110B) after being received by the gateway device, and then transmitted to UE 130A or 130B through one or more IAB nodes.

For example, referring to FIG. 1, UE 130A may transmit UL data to IAB donor 110A or 110B or receive DL data therefrom via IAB node 120A. UE 130B may transmit UL data to IAB donor 110A or receive DL data therefrom via IAB node 120C and IAB node 120B.

In an IAB deployment such as the wireless communication system 100, the radio link between an IAB donor (e.g., IAB donor 110A or 110B in FIG. 1) and an IAB node or between two IAB nodes may be referred to as a backhaul link (BL). The radio link between an IAB donor (e.g., IAB donor 110A or 110B in FIG. 1) and a UE or between an IAB node and a UE may be referred to as an access link (AL). For example, in FIG. 1, radio links 140A to 140D are BLs and radio links 150A and 150B are ALs.

A protocol layer, the backhaul adaptation protocol (BAP) layer, located above the radio link control (RLC) layer, is introduced in an IAB system and can be used to realize packet routing, bearer mapping and flow control on the wireless backhaul link.

An F1 interface may be established between an IAB node (e.g., DU part of the IAB node) and an IAB donor (e.g., IAB donor-CU). The F1 interface may support both a user plane protocol (e.g., F1-U) and a control plane protocol (e.g., F1-C). The user plane protocol of the F1 interface may include one or more of a general packet radio service (GPRS) tunneling protocol user plane (GTP-U), user datagram protocol (UDP), internet protocol (IP) and other protocols. The control plane protocol of the F1 interface may include one or more of an F1 application protocol (F1AP), stream control transport protocol (SCTP), IP, and other protocols.

Through the control plane of the F1 interface, an IAB node and an IAB donor can perform, for example, interface management, IAB-DU management, and a UE context-related configuration. Through the user plane of the F1 interface, an IAB node and an IAB donor can perform, for example, user plane data transmission and downlink transmission status feedback functions.

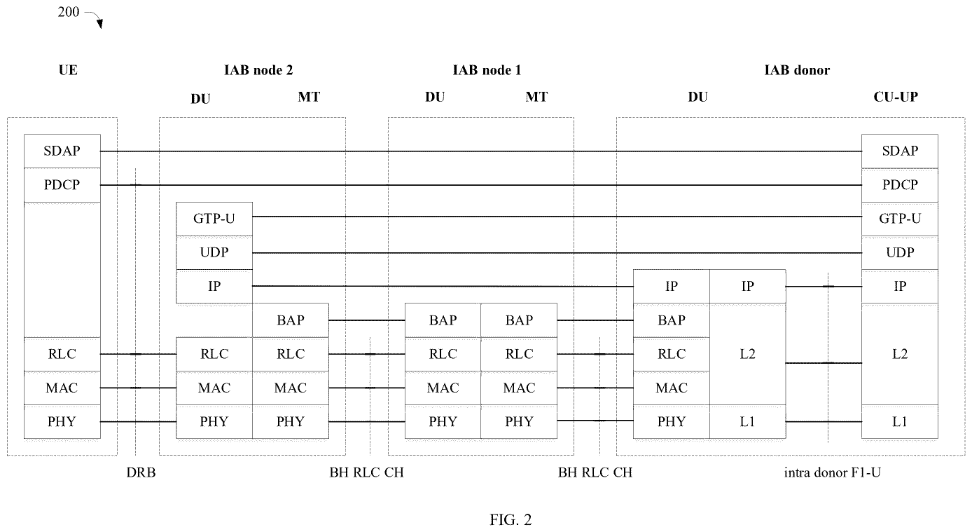

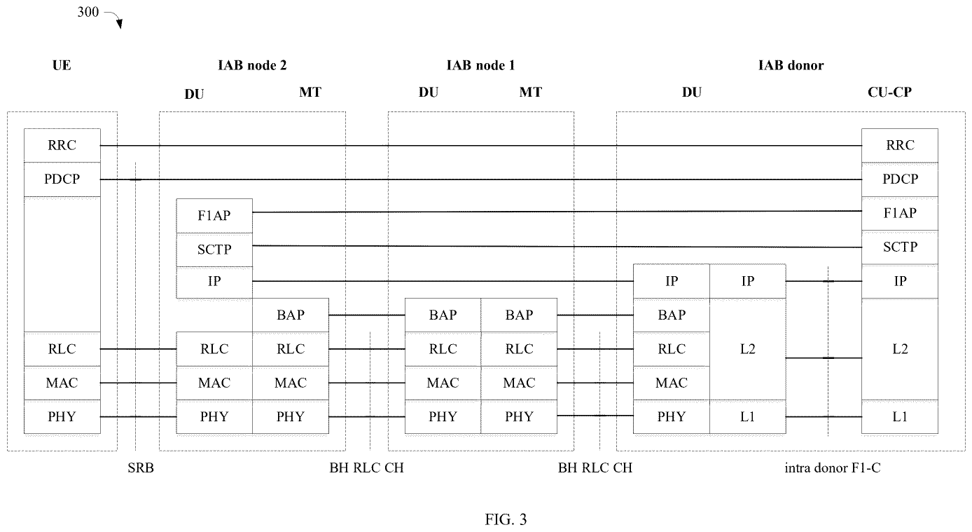

FIG. 2 illustrates an example block diagram of user plane (UP) protocol stack 200 for an IAB network according to some embodiments of the present disclosure. FIG. 3 illustrates an example block diagram of control plane (CP) protocol stack 300 for an IAB network according to some embodiments of the present disclosure. In FIGS. 2 and 3, a UE may be connected to an IAB donor via IAB node 2 and IAB node 1. In some other embodiments of the present disclosure, a UE may be connected to an IAB donor via more or less IAB nodes.

Referring to FIG. 2, the UP protocol stack of the UE may include a service data adaptation protocol (SDAP) layer, a packet data convergence protocol (PDCP) layer, a radio link control (RLC) layer, a medium access control (MAC) layer, and a physical (PHY) layer. The UP protocol stack of the DU of IAB node 2 may include a GTP-U layer, a UDP layer, an IP layer, an RLC layer, a MAC layer, and a PHY layer. The UP protocol stack of the MT of IAB node 2 or the DU or MT of IAB node 1 may include a BAP layer, an RLC layer, a MAC layer, and a PHY layer. The UP protocol stack of the DU of the IAB donor may include an IP layer, a BAP layer, an RLC layer, a MAC layer, and a PHY layer, where the PHY layer belongs to layer 1 (L1), and the BAP layer, the RLC layer, and the MAC layer belong to layer 2 (L2). The protocol stack of the CU-UP of the IAB donor may include a GTP-U layer, a UDP layer, an IP layer, an SDAP layer, a PDCP layer, an L2 layer(s), and an L1 layer.

Referring to FIG. 3, the CP protocol stack of the UE may include a radio resource control (RRC) layer, a PDCP layer, an RLC layer, a MAC layer, and a physical (PHY) layer. The CP protocol stack of the DU of IAB node 2 may include an F1AP layer, an SCTP layer, an IP layer, an RLC layer, a MAC layer, and a PHY layer. The CP protocol stack of the MT of IAB node 2 or the DU or MT of IAB node 1 may include a BAP layer, an RLC layer, a MAC layer, and a PHY layer. The CP protocol stack of the DU of the IAB donor may include an IP layer, a BAP layer, an RLC layer, a MAC layer, and a PHY layer, where the PHY layer belongs to L1, and the BAP layer, the RLC layer, and the MAC layer belong to L2. The protocol stack of the CU-CP of the IAB donor may include an RRC layer, a PDCP layer, an F1AP layer, an SCTP layer, an IP layer, an L2 layer(s), and an L1 layer.

The protocol stacks shown in FIGS. 2 and 3 are only for illustrative purposes. For example, the sequences of some of the protocol layers in the protocol stacks of FIGS. 2 and 3 may be rearranged for illustrative purposes. For example, although the SDAP and PDCP layers belong to L2, they are shown above the GTP-U layer, the UDP layer and the IP layer in the protocol stack of the CU-UP of the IAB donor in FIG. 2.

The signals between each node in an IAB network may include, for example, the following and can be applied to the present disclosure:
an IAB donor-CU and an IAB donor-DU: an F1AP message;
an IAB donor-CU and an IAB node: an FIAP message between the CU and the IAB-DU or an RRC message between the CU and the IAB-MT;
an IAB donor-CU and a UE: an RRC message;
an access IAB node and a UE: L2 control PDU such as a MAC control element (CE) or a RLC control PDU; and
an IAB node and another child or parent IAB node: L2 control PDU such as a MAC CE, a RLC control PDU, or a BAP control PDU.

As demand for improved cellular coverage and connectivity continues to increase, communications in outdoor and mobility scenarios may face more challenges. In some embodiments of the present disclosure, a mobile wireless network node which acts as a relay between a UE and the 3GPP communication network (e.g., 5G) may be employed to facilitate communications in such scenarios. The mobile wireless network node may provide, for example, an access link to UEs and connected wirelessly (e.g., using NR) through a BS (e.g., donor next-generation radio access network (NG-RAN)) to the core network. In some examples, such mobile wireless network node may also be referred to as a mobile base station relay or mobile relay. The above descriptions with respect to the wireless network node and the IAB node can be applied to the mobile base station relay. That is, a mobile base station relay can be a mobile IAB node.

In some examples, the mobile base station relay may be mounted on a vehicle. The mobile base station relay may serve UEs that are located inside or outside the vehicle, or UEs that enter or leave the vehicle. In the context of the present disclosure, inside or outside of a mobile base station relay may mean inside or outside of a vehicle or other device(s) on which the mobile wireless network node is mounted.

In some examples, the radio link used between a mobile base station relay and the served UEs, as well as between the mobile base station relay and the BS, may be a Uu link (e.g., NR-Uu), which is different from a UE relay (which uses a PC5-based link to provide, for example, indirect connection to remote UEs). In some examples, there may be at least one hop between a UE and a mobile base station relay. In some examples, there may be at least one hop between a mobile base station relay and a BS.

The employment of such mobile wireless network node is advantageous in various aspects and can be applied to various scenarios. For example, in some outdoor environments, the availability of vehicles equipped with mobile base station relays, either following a certain known/predictable itinerary (e.g., buses, trams, etc.), or situated in convenient locations (e.g., outside stadiums, hot-spot areas, or emergency sites), may provide a very opportunistic boost to cellular coverage and capacity when or where needed. Those relays may use, for example, a 5G wireless backhaul toward the macro network, and thus can offer better coverage and connectivity to neighboring UEs. Mobile relays are also very suitable for improving connectivity for users or devices inside a vehicle on which the mobile relay is mounted in different environments, for example, for passengers in buses, cars/taxis, or trains, ad-hoc/professional personnel or equipment. Such mobile wireless network node can also be used for reaching users or devices that would otherwise have no or very poor macro coverage, for example, in the case of first responders dislocated in indoor buildings/areas, using relays placed on their nearby or outside vehicles to get required coverage and connectivity.

The technical benefits of using such mobile wireless network node further include, among others, the ability to get better macro coverage than a nearby UE, for example, exploiting better radio frequency, antenna and power capabilities. In addition, besides the value for network operators and end users, worthy incentives may be found for other parties as well, for example, for vehicle manufacturers, and vehicle and fleet owners or providers, to install and operate relays in their vehicles.

Due to the mobility of a wireless network node (e.g., an IAB node), the wireless network node may need to migrate (or hand over) from one IAB donor to another IAB donor.

In some embodiments, the MT of a wireless network node may migrate from an initial (source) IAB donor to a new (target) IAB donor. For example, the MT of a wireless network node may migrate to a different parent node underneath a different CU of an IAB donor. For instance, referring back to FIG. 1, the MT of IAB node 120C or IAB node 120B may migrate from IAB donor 110A to IAB donor 110B. In this scenario, the DU of the wireless network node and the DU of the descendant node(s) of the wireless network node may retain F1 connectivity with the source IAB donor (e.g., CU of the source IAB donor). This migration may be referred to as inter-donor partial migration. The wireless network node, whose MT migrates to the target IAB donor (e.g., CU of the target IAB donor), may be referred to as a boundary wireless network node. After the inter-donor partial migration, the F1 traffic of the DU of the wireless network node and the DU of the descendant node(s) of the wireless network node may be routed via, for example, the BAP layer of the IAB topology to which the MT of the wireless network node has migrated.

In some embodiments, the DU of a wireless network node may migrate from an initial (source) IAB donor to a new (target) IAB donor. This migration may be referred to as inter-donor IAB-DU migration. In some embodiments, to execute the handover of the UEs served by the wireless network node (e.g., its DU), the wireless network node may concurrently support two logical DUs (e.g., DU #1 and DU #2), which may have F1AP associations with the source IAB donor (e.g., CU of the source IAB donor) and the target IAB donor (e.g., CU of the target IAB donor), respectively. The UEs connected to the wireless network node may be handed over from a cell of DU #1 (i.e., the source DU of the wireless network node) that has an FIAP association with the source CU (i.e., CU of the source IAB donor) to a cell of DU #2 (i.e., the target DU of the wireless network node) that has an FIAP association with the target CU (i.e., CU of the target IAB donor). After the migration of the DU of the wireless network node, the F1 interface between DU #1 and source IAB donor can be released.

In some embodiments of the present disclosure, the migration of the DU of a wireless network node may be performed independently from the migration of the MT of the wireless network node. For example, the DU and MT of a wireless network node can be migrated (or handed over) to different IAB donors (e.g., donor CUs).

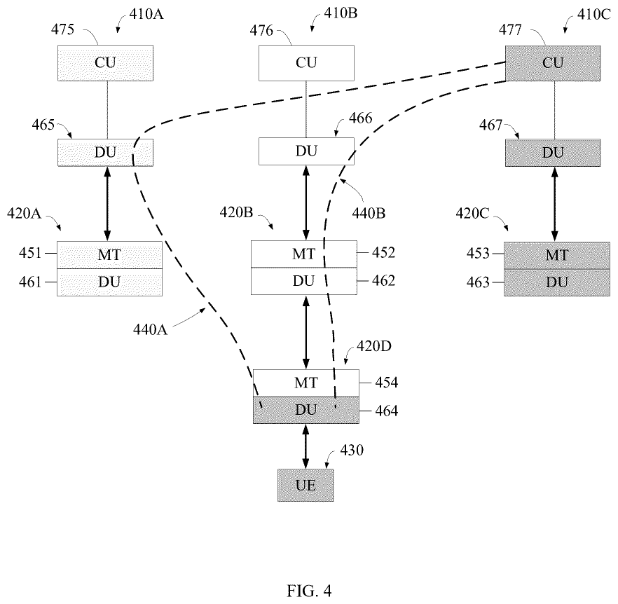

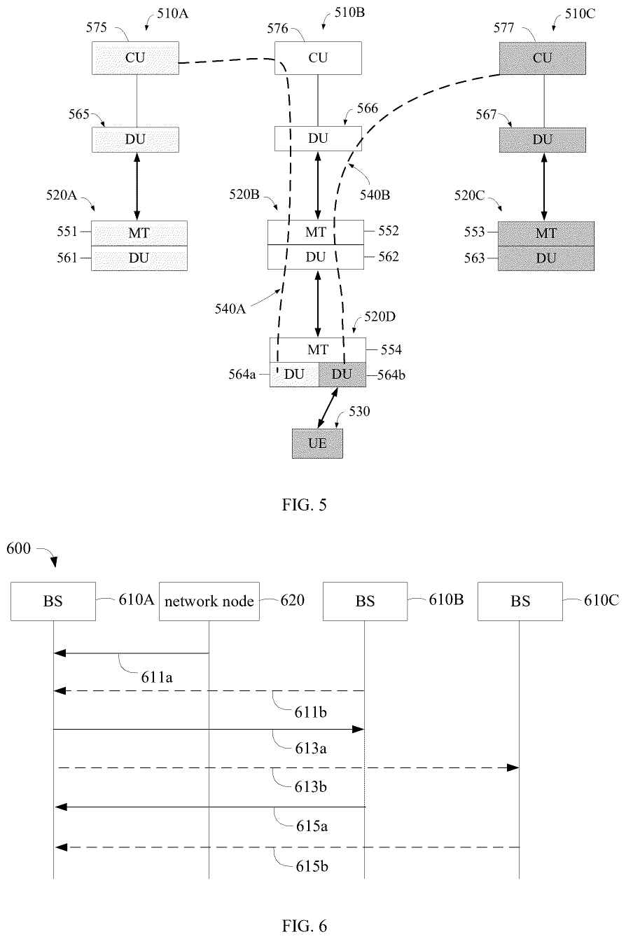

For example, FIGS. 4 and 5 show schematic diagrams of IAB node migration in accordance with some embodiments of the present disclosure. In the example of FIG. 4, the MT of a wireless network node migrates from a BS to another BS while the DU of the wireless network node connects to yet another BS (hereinafter, “Scenario 1”). In the example of FIG. 5, the DU of a wireless network node migrates from a BS to another BS while the MT of the wireless network node connects to yet another BS (hereinafter, “Scenario 2”). Details described in all of the foregoing embodiments of the present disclosure are applicable for the embodiments shown in FIGS. 4 and 5.

Referring to FIG. 4, IAB donor 410A may include CU 475 and DU 465, IAB donor 410B may include CU 476 and DU 466, and IAB donor 410C may include CU 477 and DU 467. IAB node 420A may be directly connected to IAB donor 410A and may include MT 451 and DU 461. IAB node 420B may be directly connected to IAB donor 410B and may include MT 452 and DU 462. IAB node 420C may be directly connected to IAB donor 410C and may include MT 453 and DU 463. IAB node 420D may include MT 454 and DU 464, and UE 430 may be connected to IAB node 420D. IAB node 420D may be referred to as an access IAB node of UE 430.

DU 464 of IAB node 420D may be anchored at IAB donor 410C (e.g., CU 477). MT 454 of IAB node 420D may be migrated (or handed over) from IAB donor 410A to IAB donor 410B. During the migration of MT 454, F1 transport between DU 464 and IAB donor 410C is switched from the topology of IAB donor 410A (e.g., denoted by signaling flow 440A) to the topology of IAB donor 410B (e.g., denoted by signaling flow 440B).

Referring to FIG. 5, IAB donor 510A may include CU 575 and DU 565, IAB donor 510B may include CU 576 and DU 566, and IAB donor 510C may include CU 577 and DU 567. IAB node 520A may be directly connected to IAB donor 510A and may include MT 551 and DU 561. IAB node 520B may be directly connected to IAB donor 510B and may include MT 552 and DU 562. IAB node 520C may be directly connected to IAB donor 510C and may include MT 553 and DU 563. IAB node 520D may include MT 554 and two DUs (DU 564a and DU 564b), and UE 530 may be connected to IAB node 520D. IAB node 520D may be referred to as an access IAB node of UE 530.

MT 554 of IAB node 520D may be anchored at IAB donor 510B (e.g., CU 576). The DU of IAB node 520D may be migrated from IAB donor 510A (i.e., source IAB-donor) to IAB donor 510C (i.e., target IAB-donor). Before the DU migration, only DU564a of the IAB node 520D has an F1 connection to IAB donor 510A (e.g., denoted by signaling flow 540A). During the DU migration, IAB node 520D may have two DUs (e.g., DU 564a and DU 564b as shown in FIG. 5). DU 564a may have an F1 connection to IAB donor 510A and DU 564b may have an F1 connection to IAB donor 510C (e.g., denoted by signaling flow 540B). And after the DU migration, only DU564b of the IAB node 520D has an F1 connection to IAB donor 510C. Both F1 connections are transported via the topology of IAB donor 510B.

The DU migration and MT migration shown in FIGS. 4 and 5 are only for illustrative purpose. For example, in some other embodiments, the MT and DU of a wireless network node may be anchored at the same BS (e.g., IAB donor) and the MT or the DU of the wireless network node may migrate from the source BS to a target BS (e.g., IAB donor). For example, in some other embodiments, the wireless network node may hop through one or more wireless network nodes (e.g., IAB nodes) before reaching the source or target BS, or may be directly connected to the source or target BS.

It should be noted that, although embodiments of the present disclosure are discussed under a specific network architecture (e.g., the IAB architecture) and based on certain specific components (e.g., an IAB donor or a mobile IAB node), embodiments of the present disclosure are also applicable to other similar network architectures and new service scenarios.

Several issues may need to be resolved during the migration of a wireless network node (e.g., the DU or MT migration).

For example, in both Scenario 1 (e.g., as shown in FIG. 4) and Scenario 2 (e.g., as shown in FIG. 5), the MT and DU of a wireless network node will be terminated at different BSs after the migration. As a precondition to achieve this, the two BSs should have an IP connection therebetween so that the MT and DU of the wireless network node can terminate at them. Therefore, an issue that needs to be solved is whether such IP connectivity information should be obtained before the migration so as to ensure the success of the migration. For example, referring to FIG. 4, whether IAB donor 410A should know if there is an IP connection between IAB donor 410B and IAB donor 410C before the migration of MT 454 of IAB node 420D. For example, referring to FIG. 5, whether IAB donor 510A should know if there is an IP connection between IAB donor 510B and IAB donor 510C before the migration of the DU of IAB node 520D. Further, how to obtain such information may need to be solved.

For example, the MT and DU of a wireless network node terminate at different BSs and the F1 terminating BS to which the DU of the wireless network node connects may trigger the migration of the DU of the wireless network node. An issue that needs to be solved is that how can the F1 terminating BS determine whether to perform the migration of the DU of the wireless network node to another BS. For example, referring to FIG. 5, how IAB donor 510A should determine whether to trigger the migration of the DU of IAB node 520D.

For example, the MT and DU of a wireless network node terminate at different BSs and the migration of the DU of the wireless network node may not be triggered by the F1 terminating BS to which the DU of the wireless network node connects. An issue that needs to be solved is how can the F1 terminating BS be aware of the completion of the DU migration and the target BS of the migration such that the F1 terminating BS can trigger the handover for the UEs served by the wireless network node to the target BS. For example, referring to FIG. 5, how IAB donor 510A can be aware of the completion of the migration of the DU of IAB node 520D and IAB donor 510C.

Embodiments of the present disclosure provide solutions to enhance the migration of a wireless network node, which can solve at least the above issues. More details on the embodiments of the present disclosure will be illustrated in the following text in combination with the appended drawings.

In some embodiments of the present disclosure, the DU of a network node may perform a migration from a BS (i.e., source F1 terminating BS) to another BS (i.e., target F1 terminating BS). The MT of the network node may connect to yet another BS (i.e., RRC terminating BS). As described above, during such migration, the network node may have two logical DUs which have respective F1 connections to the source and target F1 terminating BSs, and both of the F1 connections need to be transported via the topology of RRC terminating BS. However, an error case may occur in the case that the DU migration is triggered by the source F1 terminating BS, which does not know whether there is an IP connection between the RRC terminating BS and the target F1 terminating BS (or an IP connection between the DU of the RRC terminating BS and the CU of the target F1 terminating BS). To solve this issue, the source F1 terminating BS may inquire the RRC terminating BS or the target F1 terminating BS before triggering the DU migration. In addition, the source F1 terminating BS may obtain information to assist it to initiate the migration of the DU of the network node.

For example, FIG. 6 illustrates a flow chart of exemplary procedure 600 for wireless communications in accordance with some embodiments of the present disclosure.

Details described in all of the foregoing embodiments of the present disclosure are applicable for the embodiments shown in FIG. 6. For example, BSs 610A-610C may function as the IAB donors as described above and may include a CU and at least one DU. Network node 620 may function as the IAB nodes as described above, and may include an MT and at least one DU (e.g., one DU before and after DU migration or two DUs during the DU migration).

Network node 620 (e.g., DU of network node 620) may have an F1 connection with BS 610A (e.g., CU of BS 610A). Network node 620 (e.g., MT of network node 620) may have an RRC connection with BS 610B (e.g., CU of BS 610B). BS 610A and BS 610B may be referred to as an F1 terminating BS and an RRC terminating BS, respectively.

In some embodiments, the DU of network node 620 may perform a migration from BS 610A (i.e., source F1 terminating BS) to a target BS (i.e., target F1 terminating BS such as BS 610C) while the MT of network node 620 retains its connection with BS 610B. For example, BS 610A, BS 610B, BS 610C and network node 620 may function as IAB donor 510A, IAB donor 510B, IAB donor 510C, and IAB node 520D in FIG. 5.

In some embodiments, before initiating the migration of the DU of network node 620 to BS 610C, BS 610A may determine whether there is an IP connection between BS 610B and BS 610C. As will be described in detail below, the determination may be based on an inquiry initiated by BS 610A to BS 610B or BS 610C.

In some embodiments of the present disclosure, to assist BS 610A to determine whether to migrate the DU of network node 620 or not, BS 610A may need to be aware of the location of the MT of network node 620. For example, to assist BS 610A to initiate the migration of the DU of network node 620, network node 620 may, in operation 611a, transmit the location information of the MT of network node 620 to BS 610A. The information may be transmitted via the F1 interface between the DU of network node 620 and BS 610A. In some embodiments, in addition to operation 611a or instead of operation 611a, BS 610B (i.e., the RRC terminating BS) may, in operation 611b, transmit the location information of the MT of network node 620 to BS 610A. The information may be transmitted via the Xn interface between BS 610A and BS 610B.

In some embodiments of the present disclosure, in operation 613a, BS 610A may transmit to BS 610B an inquiry about the IP connectivity of BS 610B (e.g., an inquiry about whether there is an IP connection between BS 610B and BS 610C). In some embodiments of the present disclosure, in addition to operation 613a or instead of operation 613a, BS 610A may, in operation 613b, transmit to BS 610C an inquiry about the IP connectivity of BS 610C (e.g., an inquiry about whether there is an IP connection between BS 610B and BS 610C). The above inquiry may be transmitted via the Xn interface between BS 610A and BS 610B or between BS 610A and BS 610C.

In the case that operation 613a is performed, BS 610B may transmit to BS 610A a response to the inquiry in operation 615a. In the case that operation 613b is performed, BS 610C may transmit to BS 610A a response to the inquiry in operation 615b. BS 610A may then determine whether to trigger the migration of the DU of network node 620 from BS 610A to BS 610C based on the response. For example, in the case that the response indicates that there is an IP connection between BS 610B and BS 610C (i.e., positive feedback), BS 610A may initiate the migration of the DU of network node 620 to BS 610C. Otherwise, in the case that the response indicates that there is no IP connection between BS 610B and BS 610C (i.e., negative feedback), BS 610A may not initiate the migration of the DU of network node 620 to BS 610C.

In some embodiments, to initiate the migration of the DU of network node 620 to BS 610C, BS 610A may transmit a migration command to network node 620 (not shown in FIG. 6). Network node 620 may have two logical DUs (denoted as DU #A1 and DU #A2), wherein DU #A1 has an F1 connection to BS 610A, and DU #A2 may set up an F1 connection to BS 610C via the BH links under BS 610B. After the cells of DU #A2 have been activated, all UEs connected to DU #A1 may perform a handover from the cell(s) of DU #A1 to the cell(s) of DU #A2.

In some other embodiments, BS 610A may transmit a migration command (e.g., a DU or F1 migration request) to BS 610C to initiate the migration of the DU of network node 620 to BS 610C.

It should be appreciated by persons skilled in the art that the sequence of the operations in exemplary procedure 600 may be changed and some of the operations in exemplary procedure 600 may be eliminated or modified, without departing from the spirit and scope of the disclosure.

In some embodiments of the present disclosure, the MT of a network node may perform a migration from a BS (i.e., source RRC terminating BS) to another BS (i.e., target RRC terminating BS). The DU of the network node may connect to yet another BS (i.e., F1 terminating BS). As described above, during such migration, the F1 transport between the DU of the network node and the F1 terminating BS is switched from the topology of the source RRC terminating BS to the topology of the target RRC terminating BS. However, an error case may occur in the case that the MT migration is triggered by the source RRC terminating BS, which does not know whether there is an IP connection between the target RRC terminating BS and the F1 terminating BS (or an IP connection between the DU of the target RRC terminating BS and the CU of the F1 terminating BS). To solve this issue, the source RRC terminating BS may inquire the target RRC terminating BS or the F1 terminating BS about the IP connectivity before triggering the MT migration.

For example, FIG. 7 illustrates a flow chart of exemplary procedure 700 for wireless communications in accordance with some embodiments of the present disclosure.

Details described in all of the foregoing embodiments of the present disclosure are applicable for the embodiments shown in FIG. 7. For example, BSs 710A-710C may function as the IAB donors as described above and may include a CU and at least one DU. Network node 720 may function as the IAB nodes as described above, and may include an MT and at least one DU (e.g., one DU before and after DU migration or two DUs during the DU migration).

Network node 720 (e.g., DU of network node 720) may have an F1 connection with BS 710C (e.g., CU of BS 710C). Network node 720 (e.g., MT of network node 720) may have an RRC connection with BS 710A (e.g., CU of BS 710A). BS 710C and BS 710A may be referred to as an F1 terminating BS and an RRC terminating BS, respectively.

In some embodiments, the MT of network node 720 may perform a migration from BS 710A (i.e., source RRC terminating BS) to a target BS (i.e., target RRC terminating BS such as BS 710B) while the DU of network node 720 retains its connection with BS 710C. For example, BS 710A, BS 710B, BS 710C and network node 720 may function as IAB donor 410A, IAB donor 410B, IAB donor 410C, and IAB node 420D in FIG. 4.

In some embodiments, BS 710A may trigger the migration of the MT of network node 720 (e.g., to BS 710B) based on a measurement report from the MT of network node 720. Before initiating the migration of the MT of network node 720 to BS 710B, BS 710A may determine whether there is an IP connection between BS 710B and BS 710C. As will be described in detail below, the determination may be based on an inquiry initiated by BS 710A to BS 710B or BS 710C.

In some embodiments of the present disclosure, in operation 713a, BS 710A may transmit to BS 710B an inquiry about the IP connectivity of BS 710B (e.g., an inquiry about whether there is an IP connection between BS 710B and BS 710C). In some embodiments of the present disclosure, in addition to operation 713a or instead of operation 713a, BS 710A may, in operation 713b, transmit to BS 710C an inquiry about the IP connectivity of BS 710C (e.g., an inquiry about whether there is an IP connection between BS 710B and BS 710C). The above inquiry may be transmitted via the Xn interface between BS 710A and BS 710B or between BS 710A and BS 710C.

In the case that operation 713a is performed, BS 710B may transmit to BS 710A a response to the inquiry in operation 715a. In the case that operation 713b is performed, BS 710C may transmit to BS 710A a response to the inquiry in operation 715b. BS 710A may then determine whether to trigger the migration of the MT of network node 720 from BS 710A to BS 710B based on the response. For example, in the case that the response indicates that there is an IP connection between BS 710B and BS 710C (i.e., positive feedback), BS 710A may initiate the migration of the MT of network node 720 to BS 710B. Otherwise, in the case that the response indicates that there is no IP connection between BS 710B and BS 710C (i.e., negative feedback), BS 710A may not initiate the migration of the MT of network node 720 to BS 710B.

In some embodiments, to initiate the migration of the MT of network node 720 to BS 710B, BS 710A may transmit a migration command (e.g., handover command) to BS 710B (not shown in FIG. 7). The MT of network node 720 may perform the migration (or handover) from BS 710A to BS 710B as a UE. The F1 transport between the DU of network node 720 and BS 710C is switched from the topology of BS 710A to the topology of BS 710B.

It should be appreciated by persons skilled in the art that the sequence of the operations in exemplary procedure 700 may be changed and some of the operations in exemplary procedure 700 may be eliminated or modified, without departing from the spirit and scope of the disclosure.

In some embodiments of the present disclosure, a procedure between two BSs is introduced to exchange IP connectivity information of the two BSs. For example, the F1 terminating BS and RRC terminating BS of a network node may exchange such information via the Xn interface therebetween. Such procedure can be triggered by either the F1 terminating BS or the RRC terminating BS. The F1 terminating BS or RRC terminating BS can use the exchanged information to determine whether to initiate or perform a DU or MT migration of the network node to a different BS.

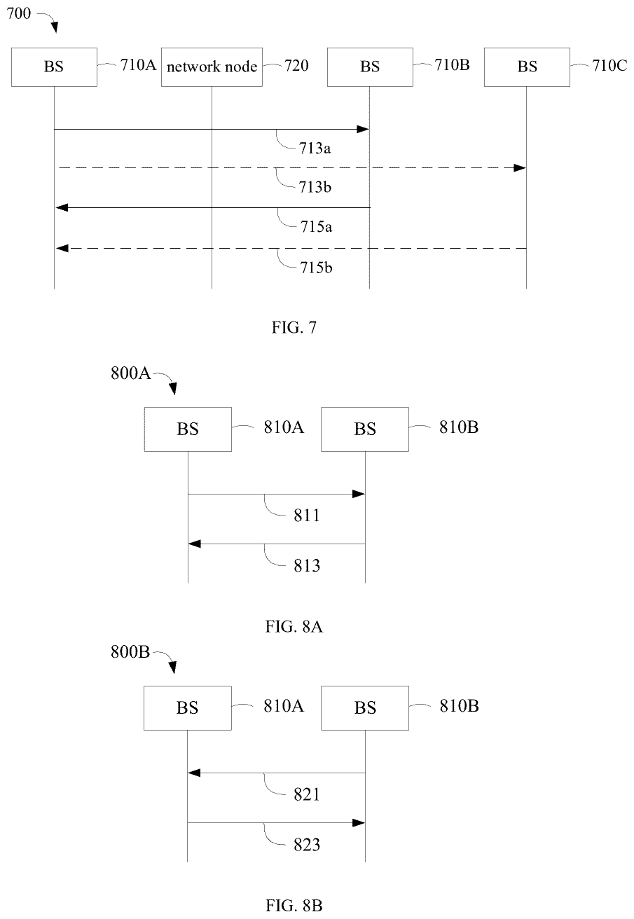

For example, FIGS. 8A and 8B illustrate flow charts of exemplary procedures 800A and 800B for wireless communications in accordance with some embodiments of the present disclosure. Exemplary procedures 800A and 800B can be used to exchange the IP connectivity information of two BSs.

Details described in all of the foregoing embodiments of the present disclosure are applicable for the embodiments shown in FIGS. 8A and 8B. For example, BSs 810A and 810B may function as the IAB donors as described above and may include a CU and at least one DU.

In some embodiments of the present disclosure, BSs 810A and 810B may be the F1 terminating BS and RRC terminating BS of a network node (not shown in FIG. 8). That is, the network node (e.g., DU of the network node) may have an F1 connection with BS 810A (e.g., CU of BS 810A); and the network node (e.g., MT of the network node) may have an RRC connection with BS 810B (e.g., CU of BS 810B).

Referring to FIG. 8A, BS 810A may transmit, to BS 810B, information (denoted as information #A1) regarding IP connectivity to BS 810A in operation 811. In some embodiments, information #A1 may include a list of BSs, and each BS in this list has an IP connection to BS 810A. In response to the reception of information #A1, BS 810B may transmit, to BS 810A, information (denoted as information #A2) regarding IP connectivity to BS 810B in operation 813. In some embodiments, information #A2 may include a list of BSs, and each BS in this list has an IP connection to BS 810B.

Referring to FIG. 8B, BS 810B may transmit, to BS 810A, information (denoted as information #B1) regarding IP connectivity to BS 810B in operation 821. In some embodiments, information #B1 may include a list of BSs, and each BS in this list has an IP connection to BS 810B. In response to the reception of information #B1, BS 810A may transmit, to BS 810B, information (denoted as information #B2) regarding IP connectivity to BS 810A in operation 823. In some embodiments, information #B2 may include a list of BSs, and each BS in this list has an IP connection to BS 810A.

In some embodiments of the present disclosure, BS 810A can use the IP connectivity information to BS 810B (e.g., information #A2 or information #B1) to determine whether to initiate a DU migration of the network node to a BS (denoted as BS #C1) different from both BS 810A and BS 810B. For example, BS 810A can determine whether there is an IP connection between BS 810B and BS #C1 based on the IP connectivity information to BS 810B, and may initiate a migration of the DU of the wireless network node to BS #C1 if it is determined that BS 810B and BS #C1 have an IP connection.

In some embodiments of the present disclosure, BS 810B can use the IP connectivity information to BS 810A (e.g., information #A1 or information #B2) to determine whether to initiate an MT migration of the network node to a BS (denoted as BS #C2) different from both BS 810A and BS 810B. For example, BS 810B can determine whether there is an IP connection between BS 810B and BS #C2 based on the IP connectivity information to BS 810A, and may initiate a migration of the MT of the wireless network node to BS #C2 if it is determined that BS 810B and BS #C2 have an IP connection.

It should be appreciated by persons skilled in the art that the sequences of the operations in exemplary procedures 800A and 800B may be changed and some of the operations in exemplary procedures 800A and 800B may be eliminated or modified, without departing from the spirit and scope of the disclosure.

As illustrated above, the IP connectivity information may be obtained before the MT or DU migration of a network node is performed. For example, the MT or DU migration of a network node is performed only when the source RRC terminating BS or source F1 terminating BS obtain the information that the target RRC terminating BS or target F1 terminating BS has the IP connection to the F1 terminating BS or RRC terminating BS. However, in some other embodiments of the present disclosure, such information may not necessarily be obtained before the MT or DU migration of the network node.

For example, FIG. 9 illustrates a flow chart of exemplary procedure 900 for wireless communications in accordance with some embodiments of the present disclosure.

Details described in all of the foregoing embodiments of the present disclosure are applicable for the embodiments shown in FIG. 9. For example, BSs 910A and 910B may function as the IAB donors as described above and may include a CU and at least one DU.

In some embodiments of the present disclosure, BS 910A may be the RRC terminating BS of a network node (not shown in FIG. 9). That is, the network node (e.g., MT of the network node) may have an RRC connection with BS 910A (e.g., CU of BS 910A). The network node (e.g., DU of the network node) may have an F1 connection with another BS (not shown in FIG. 9 and denoted as BS #C3 for clarity).

Referring to FIG. 9, BS 910A (i.e., source RRC terminating BS) may, in operation 911, transmit a handover request to BS 910B (i.e., target RRC terminating BS) to hand over the MT of the network node to BS 910B. For example, BS 910A and BS 910B may function as IAB donor 410A and IAB donor 410B in FIG. 4. In some embodiments, the handover request may include information associated with BS #C3 which has an F1 connection to the network node. For example, the information may indicate an identifier of BS #C3.

In some embodiments of the present disclosure, if BS 910B has an IP connection to BS #C3, BS 910B may accept the handover in operation 913, and may transmit a response to the handover request (e.g., positive feedback such as a handover request acknowledge message) to BS 910A in operation 915.

In some embodiments of the present disclosure, if BS 910B does not have an IP connection to BS #C3, BS 910B may refuse the handover in operation 913, and may transmit a response to the handover request (e.g., negative feedback such as a handover preparation failure message) to BS 910A in operation 915. In some embodiments, the response may indicate that the handover (or migration) is refused due to no IP connection between BS #C3 and BS 910B. For example, the handover preparation failure message may include a cause value for no IP connection.

In some embodiments of the present disclosure, BS 910A may be the F1 terminating BS of a network node (not shown in FIG. 9). That is, the network node (e.g., DU of the network node) may have an F1 connection with BS 910A (e.g., CU of BS 910A). The network node (e.g., MT of the network node) may have an RRC connection with another BS (not shown in FIG. 9 and denoted as BS #C4 for clarity).

Referring to FIG. 9, BS 910A (i.e., source F1 terminating BS) may, in operation 911, transmit a request (e.g., a DU or F1 migration request) to BS 910B (i.e., target F1 terminating BS) to migrate the DU of the network node to BS 910B. For example, BS 910A and BS 910B may function as IAB donor 510A and IAB donor 510C in FIG. 5. In some embodiments, the request may include information associated with BS #C4 which has an RRC connection to the network node. For example, the information may indicate an identifier of BS #C4.

In some embodiments of the present disclosure, if BS 910B has an IP connection to BS #C4, BS 910B may accept the request in operation 913, and may transmit a response to the request (e.g., positive feedback) to BS 910A in operation 915.

In some embodiments of the present disclosure, if BS 910B does not have an IP connection to BS #C4, BS 910B may refuse the request in operation 913, and may transmit a response to the request (e.g., negative feedback) to BS 910A in operation 915. In some embodiments, the response may indicate that the migration is refused due to no IP connection between BS #C4 and BS 910B. For example, the response message may indicate a cause value of no IP connection.

It should be appreciated by persons skilled in the art that the sequence of the operations in exemplary procedure 900 may be changed and some of the operations in exemplary procedure 900 may be eliminated or modified, without departing from the spirit and scope of the disclosure.

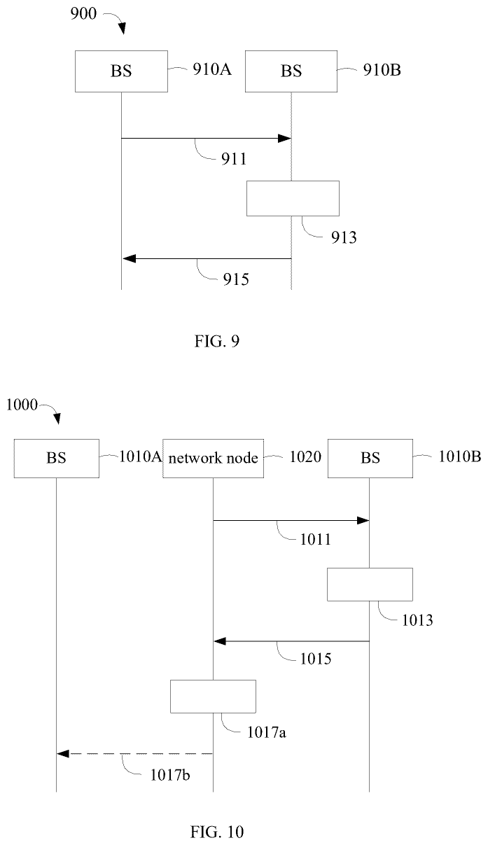

For example, FIG. 10 illustrates a flow chart of exemplary procedure 1000 for wireless communications in accordance with some embodiments of the present disclosure.

Details described in all of the foregoing embodiments of the present disclosure are applicable for the embodiments shown in FIG. 10. For example, BSs 1010A and 1010B may function as the IAB donors as described above and may include a CU and at least one DU. Network node 1020 may function as the IAB nodes as described above, and may include an MT and at least one DU (e.g., one DU before and after DU migration or two DUs during the DU migration).

Network node 1020 (e.g., DU of network node 1020) may have an F1 connection with BS 1010A (e.g., CU of BS 1010A). Network node 1020 (e.g., MT of network node 1020) may have an RRC connection with BS 1010B (e.g., CU of BS 1010B). BS 1010A and BS 1010B may be referred to as an F1 terminating BS and an RRC terminating BS, respectively.

In some embodiments, the DU of network node 1020 may perform a migration from BS 1010A (i.e., source F1 terminating BS) to a target BS (i.e., target F1 terminating BS, which is not shown in FIG. 10 and is denoted as BS #C5 for clarity), while the MT of network node 1020 retains its connection with BS 1010B. For example, BS 1010A, BS 1010B and network node 1020 may function as IAB donor 510A, IAB donor 510B, and IAB node 520D in FIG. 5.

In some embodiments, the migration of the DU of network node 1020 may be triggered by the F1 terminating BS (e.g., BS 1010A) of network node 1020. In some embodiments, the migration of the DU of network node 1020 may not be triggered by the F1 terminating BS (e.g., BS 1010A) of network node 1020. For example, the migration may be triggered by network node 1020 itself or by an operation administration and maintenance (OAM) entity.

For example, in some embodiments, BS 1010A may trigger the DU migration, and may transmit a migration command to network node 1020 to migrate its DU from BS 1010A to BS #C5. In some embodiments, to assist BS 1010A to determine whether to migrate the DU of network node 1020 or not, BS 1010A may need to be aware of the location of the MT of network node 1020. For example, to assist BS 1010A to initiate the migration of the DU of network node 1020, BS 1010A may obtain the location information of the MT of network node 1020 from network node 1020, BS 1010B or both. For example, the location information may be obtained via the F1 interface between the DU of network node 1020 and BS 1010A. For example, the location information may be obtained via the Xn interface between BS 1010A and BS 1010B.

During the migration of the DU of network node 1020, network node 1020 may have two logical DUs (denoted as DU #B1 and DU #B2), wherein DU #B1 has an F1 connection to BS 1010A, and network node 1020 (e.g., DU #B2) may need to set up an F1 connection to BS #C5. In response to the initiating or triggering of the DU migration (e.g., receiving a migration command from BS 1010A or network node 1020 itself triggering the DU migration), network node 1020 (e.g., DU #B2) may try to transmit an F1 setup request to BS #C5 (e.g., CU of BS #C5). For example, DU #B2 may try to transmit the F1 setup request message to BS #C5 via BS 1010B. For example, in operation 1011, BS 1010B (e.g., DU of BS 1010B) may receive the F1 setup request message from network node 1020.

In some embodiments, BS 1010B (e.g., DU of BS 1010B) cannot transmit the F1 setup request message to BS #C5 (e.g., CU of BS #C5) because there is no IP connection between BS 1010B (e.g., DU of BS 1010B) and BS #C5 (e.g., CU of BS #C5). In this case, the DU of BS 1010B may, in operation 1013, inform the CU of BS 1010B with “non-IP-routable of a UL packet(s) for F1 setup request message” (this can be identified by the source/target IP address).

Then, in operation 1015, BS 1010B (e.g., CU of BS 1010B) may inform network node 1020 (e.g., MT of network node 1020) about the failure to deliver the UL packet(s) for F1 setup request message to BS #C5 (which is identified by the target IP address). In some embodiments, the reason of the failure (i.e., no IP connection between BS #C5 and BS 1010B) may also be informed to network node 1020. For example, the message transmitted in operation 1015 may indicate a cause value of no IP connection.

In the case that the DU migration is triggered by network node 1020, network node 1020 may cancel the DU migration to BS #C5 in operation 1017a in response to the reception of the information in operation 1015.

In the case that the DU migration is triggered by BS 1010A, network node 1020 (e.g., DU #B1) may inform BS 1010A (e.g., CU of BS 1010A) about the failure of the F1 setup in operation 1017b in response to the reception of the information in operation 1015. In some embodiments, the reason of the failure (i.e., no IP connection between BS #C5 and BS 1010B) may also be transmitted to BS 1010A. For example, the message transmitted in operation 1017b may indicate a cause value of no IP connection. Based on the information received in operation 1017b, BS 1010A may cancel the DU migration to BS #C5.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

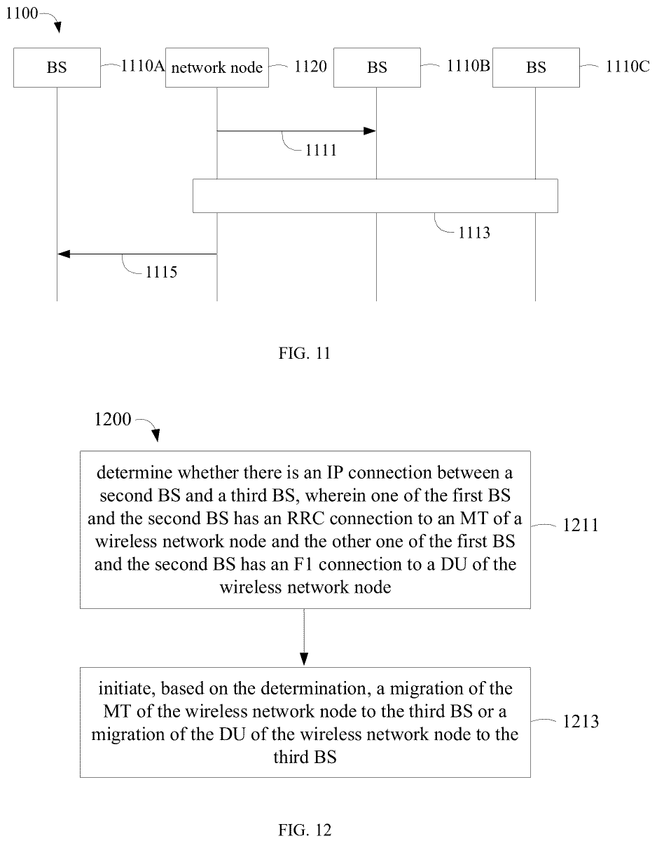

For example, FIG. 11 illustrates a flow chart of exemplary procedure 1100 for wireless communications in accordance with some embodiments of the present disclosure.

Details described in all of the foregoing embodiments of the present disclosure are applicable for the embodiments shown in FIG. 11. For example, BSs 1110A-1110C may function as the IAB donors as described above and may include a CU and at least one DU. Network node 1120 may function as the IAB nodes as described above, and may include an MT and at least one DU (e.g., one DU before and after DU migration or two DUs during the DU migration).

Network node 1120 (e.g., DU of network node 1120) may have an F1 connection with BS 1110A (e.g., CU of BS 1110A). Network node 1120 (e.g., MT of network node 1120) may have an RRC connection with BS 1110B (e.g., CU of BS 1110B). BS 1110A and BS 1110B may be referred to as an F1 terminating BS and an RRC terminating BS, respectively.

In some embodiments, the DU of network node 1120 may perform a migration from BS 1110A (i.e., source F1 terminating BS) to a target BS (i.e., target F1 terminating BS such as BS 1110C), while the MT of network node 1120 retains its connection with BS 1110B. For example, BS 1110A, BS 1110B, BS 1110C and network node 1120 may function as IAB donor 510A, IAB donor 510B, IAB donor 510C, and IAB node 520D in FIG. 5.

In some embodiments, the migration of the DU of network node 1120 may not be triggered by the F1 terminating BS (e.g., BS 1110A) of network node 1120. For example, the migration may be triggered by network node 1120 itself or by an OAM entity.

During the migration of the DU of network node 1120, network node 1120 may have two logical DUs (denoted as DU #C1 and DU #C2), wherein DU #C1 has an F1 connection to BS 1110A, and network node 1120 (e.g., DU #C2) may need to set up an F1 connection to BS 1110C. In response to the initiating or triggering of the DU migration, network node 1120 (e.g., DU #C2) may try to transmit an F1 setup request to BS 1110C (e.g., CU of BS 1110C). For example, DU #C2 may try to transmit the F1 setup request message to BS 1110C via BS 1110B. For example, in operation 1111, BS 1110B (e.g., DU of BS 1110B) may receive the F1 setup request message from network node 1120.

In some embodiments, the F1 setup request in the context of the present disclosure may also be referred to as a request for a DU migration, a request to trigger a DU migration or other similar names.

In operation 1113, BS 1110B may transmit the F1 setup request message to BS 1110C and network node 1120 (e.g., DU #C2) may set up an F1 connection to BS 1110C (e.g., CU of BS 1110C) after receiving an F1 setup response message from BS 1110C. For example, network node 1120 may receive positive feedback as a response to the F1 setup request (i.e., the F1 setup response message). After the F1 setup, the cells on DU #C2 have been activated to serve UEs.

BS 1110A needs to be informed of the F1 setup completion so as to migrate the UEs served by cell(s) of DU #C1 to cell(s) of DU #C2 (or put another way, migrate from BS 1110A to BS 1110C).

In some embodiments of the present disclosure, network node 1120 may, in operation 1115, transmit a message indicating F1 interface setup completion between network node 1120 and BS 1110C (e.g., CU of BS 1110C) to BS 1110A in response to the reception of the response in operation 1113. For example, DU #C1 may inform the CU of BS 1110A that DU #C2 has setup an F1 interface to BS 1110C. In some embodiments, the message may include the identifier of BS 1110C (e.g., ID of CU of BS 1110C).

BS 1110A may then trigger the handover of the UEs served by network node 1120 (e.g., DU #C1). For example, BS 1110A may transmit at least one handover request to BS 1110C (e.g., CU of BS 1110C) based on the identifier of BS 1110C. The handover request may be transmitted for each served UE or may be a group based handover request for all the served UEs.

In some other embodiments of the present disclosure, BS 1110A (e.g., CU of BS 1110A) may receive an F1 interface setup completion indication from BS 1110C (e.g., CU of BS 1110C). To achieve this, network node 1120 may include the identifier of BS 1110A (e.g., ID of CU of BS 1110A) in the F1 setup request (e.g., in operation 1111) such that BS 1110C (e.g., CU of BS 1110C) can transmit an F1 interface setup completion indication to BS 1110A (e.g., CU of BS 1110A) (not shown in FIG. 11). The F1 interface setup completion indication may include information to identify network node 1120 (e.g., gNB-DU ID of the network node 1120). In response to receiving the indication, BS 1110A can trigger the handover of the UEs served by network node 1120 (e.g., DU #C1) as described above. In these embodiments, operation 1115 may be omitted.

It should be appreciated by persons skilled in the art that the sequence of the operations in exemplary procedure 1100 may be changed and some of the operations in exemplary procedure 1100 may be eliminated or modified, without departing from the spirit and scope of the disclosure.

In some embodiments of the present disclosure, in response to a migration of the DU of a network node (e.g., to a target F1 terminating BS, which is denoted as BS #C6 for clarity) being triggered, the network node may determine whether there is an IP connection between the RRC terminating BS (denoted as BS #B6 for clarity) of the network node and BS #C6 before transmitting the F1 setup request. In these embodiments, the network node may terminate its F1 connection to BS #B6 or another BS. For example, the network node may transmit an inquiry about whether there is an IP connection between BS #B6 and BS #C6 to BS #B6. The transmission of the F1 setup request may be based on a response to the inquiry from BS #B6. For example, in the case that the response indicates no IP connection between BS #B6 and BS #C6 (e.g., negative feedback), the migration of the DU of the network node may be canceled. For example, in the case that the response indicates that there is an IP connection between BS #B6 and BS #C6 (e.g., positive feedback), the network node may transmit the F1 setup request to BS #B6.

The above procedure used by the network node to obtain the IP connectivity information can be applied to the foregoing embodiments of the present disclosure. For example, in exemplary procedure 1000, network node 1020 may obtain such IP connectivity information before operation 1011. When negative feedback is obtained, operations 1011 to 1015 may be omitted. For example, in exemplary procedure 1100, network node 1120 may obtain such IP connectivity information before operation 1111. When positive feedback is obtained, network node 1120 may perform operation 1111.

It should be noted that the above procedure used by a network node to obtain the IP connectivity information not only can be applied to Scenario 1 and Scenario 2, but also applied to all cases when a migration of the DU of the network node is triggered.

FIG. 12 illustrates a flow chart of exemplary procedure 1200 for wireless communications in accordance with some embodiments of the present disclosure. Details described in all of the foregoing embodiments of the present disclosure are applicable for the embodiments shown in FIG. 12. Exemplary procedure 1200 may be performed by a BS (e.g., an IAB donor).

Referring to FIG. 12, in operation 1211, a BS (denoted as first BS) may determine whether there is an IP connection between another BS (denoted as second BS) and yet another BS (denoted as third BS), wherein one of the first BS and the second BS has an RRC connection to an MT of a wireless network node and the other one of the first BS and the second BS has an F1 connection to a DU of the wireless network node. In some examples, the wireless network node may be an IAB node. In some examples, the first, second and third BS may be an IAB donor.

In operation 1213, the first BS may initiate, based on the determination, a migration of the MT of the wireless network node to the third BS or a migration of the DU of the wireless network node to the third BS.

For example, the first BS is the (source) RRC terminating BS of the wireless network node, and the second BS is the F1 terminating BS of the wireless network node, and the first BS may initiate a migration of the MT of the wireless network node to the third BS (i.e., the target RRC terminating BS). For example, the second BS is the RRC terminating BS of the wireless network node while the first BS is the (source) F1 terminating BS of the wireless network node, and the first BS may initiate a migration of the DU of the wireless network node to the third BS (i.e., the target F1 terminating BS).

In some embodiments of the present disclosure, to determine whether there is an IP connection between the second BS and the third BS, the first BS may: initiate, to the second BS, the third BS, or both, an inquiry about whether there is an IP connection between the second BS and the third BS; and determine whether there is an IP connection between the second BS and the third BS based on a response to the inquiry from the second BS, the third BS, or both.

In some embodiments of the present disclosure, the first BS may receive, from the wireless network node or the second BS, location information of the MT of the wireless network node to assist the first BS to initiate the migration of the DU of the wireless network node.

In some embodiments of the present disclosure, the first BS may receive, from the second BS, first information regarding IP connectivity to the second BS. The determination of whether there is an IP connection between the second BS and the third BS is based on the first information.

In some embodiments of the present disclosure, the first BS may transmit, to the second BS, second information regarding IP connectivity to the first BS. In some examples, the second information is transmitted in response to the reception of the first information. In some examples, the first information is received in response to the transmission of the second information.

In some embodiments of the present disclosure, the first information includes a first list of BSs, and each BS in the first list of BSs has an IP connection to the second BS, and the second information includes a second list of BSs, and each BS in the second list of BSs has an IP connection to the first BS.

It should be appreciated by persons skilled in the art that the sequence of the operations in exemplary procedure 1200 may be changed and some of the operations in exemplary procedure 1200 may be eliminated or modified, without departing from the spirit and scope of the disclosure.

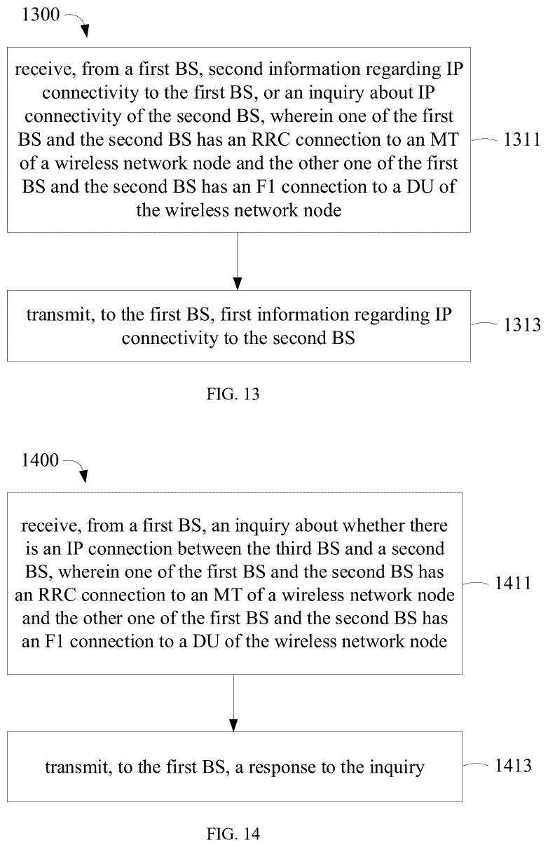

FIG. 13 illustrates a flow chart of exemplary procedure 1300 for wireless communications in accordance with some embodiments of the present disclosure. Details described in all of the foregoing embodiments of the present disclosure are applicable for the embodiments shown in FIG. 13. Exemplary procedure 1300 may be performed by a BS (e.g., an IAB donor).

Referring to FIG. 13, in operation 1311, a BS (denoted as second BS) may receive, from another BS (denoted as first BS), second information regarding IP connectivity to the first BS, or an inquiry about IP connectivity of the second BS, wherein one of the first BS and the second BS has an RRC connection to an MT of a wireless network node and the other one of the first BS and the second BS has an F1 connection to a DU of the wireless network node. In some examples, the wireless network node may be an IAB node.

In operation 1313, the second BS may transmit, to the first BS, first information regarding IP connectivity to the second BS.

In some embodiments of the present disclosure, the first information is transmitted in response to the inquiry, the inquiry is about whether there is an IP connection between the second BS and yet another BS (denoted as third BS), and the first information indicates IP connectivity between the second BS and the third BS. In some examples, the first, second and third BS may be an IAB donor.

In some embodiments of the present disclosure, the second BS may transmit location information of the MT of the wireless network node to the first BS in the case that the second BS has an RRC connection to the MT of the wireless network node.

In some embodiments of the present disclosure, the first information is transmitted in response to the reception of the second information. In some embodiments of the present disclosure, the second information is received in response to the transmission of the first information.

In some embodiments of the present disclosure, the first information includes a first list of BSs, and each BS in the first list of BSs has an IP connection to the second BS. In some embodiments of the present disclosure, the second information includes a second list of BSs, and each BS in the second list of BSs has an IP connection to the first BS.

It should be appreciated by persons skilled in the art that the sequence of the operations in exemplary procedure 1300 may be changed and some of the operations in exemplary procedure 1300 may be eliminated or modified, without departing from the spirit and scope of the disclosure.

FIG. 14 illustrates a flow chart of exemplary procedure 1400 for wireless communications in accordance with some embodiments of the present disclosure. Details described in all of the foregoing embodiments of the present disclosure are applicable for the embodiments shown in FIG. 14. Exemplary procedure 1400 may be performed by a BS (e.g., an IAB donor).

Referring to FIG. 14, in operation 1411, a BS (denoted as third BS) may receive, from another BS (denoted as first BS), an inquiry about whether there is an IP connection between the third BS and yet another BS (denoted as second BS), wherein one of the first BS and the second BS has an RRC connection to an MT of a wireless network node and the other one of the first BS and the second BS has an F1 connection to a DU of the wireless network node. In some examples, the wireless network node may be an IAB node. In some examples, the first, second and third BS may be an IAB donor.

In operation 1413, the third BS may transmit, to the first BS, a response to the inquiry.

In some embodiments of the present disclosure, in response to the response indicating that there is an IP connection between the third BS and the second BS, the third BS may: receive, from the one of the first BS and the second BS, a request to migrate the MT of the wireless network node to the third BS; or receive, from the other one of the first BS and the second BS or the wireless network node, a request to migrate the DU of the wireless network node to the third BS.

It should be appreciated by persons skilled in the art that the sequence of the operations in exemplary procedure 1400 may be changed and some of the operations in exemplary procedure 1400 may be eliminated or modified, without departing from the spirit and scope of the disclosure.

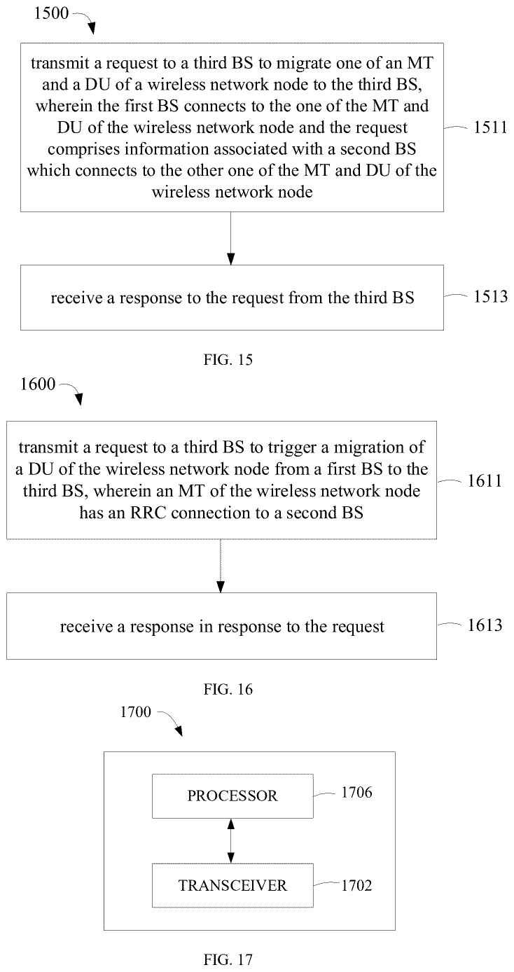

FIG. 15 illustrates a flow chart of exemplary procedure 1500 for wireless communications in accordance with some embodiments of the present disclosure. Details described in all of the foregoing embodiments of the present disclosure are applicable for the embodiments shown in FIG. 15. Exemplary procedure 1500 may be performed by a BS (e.g., an IAB donor).

Referring to FIG. 15, in operation 1511, a BS (denoted as first BS) may transmit a request to another BS (denoted as third BS) to migrate one of an MT and a DU of a wireless network node to the third BS, wherein the first BS connects to the one of the MT and DU of the wireless network node and the request comprises information associated with yet another BS (denoted as second BS) which connects to the other one of the MT and DU of the wireless network node. In some examples, the wireless network node may be an IAB node. In some examples, the first, second and third BS may be an IAB donor.

In operation 1513, the first BS may receive a response to the request from the third BS.

In some embodiments of the present disclosure, the response indicates that the migration is refused due to no IP connection between the second BS and the third BS. For example, the response may indicate a cause value of no IP connection.

In some embodiments of the present disclosure, the information associated with the second BS includes an identifier of the second BS. For example, the identifier may be an identifier of the CU of the second BS.

It should be appreciated by persons skilled in the art that the sequence of the operations in exemplary procedure 1500 may be changed and some of the operations in exemplary procedure 1500 may be eliminated or modified, without departing from the spirit and scope of the disclosure.

FIG. 16 illustrates a flow chart of exemplary procedure 1600 for wireless communications in accordance with some embodiments of the present disclosure. Details described in all of the foregoing embodiments of the present disclosure are applicable for the embodiments shown in FIG. 16. Exemplary procedure 1600 may be performed by a network node (e.g., an IAB node).

Referring to FIG. 16, in operation 1611, a network node may transmit a request to a BS (denoted as third BS) to trigger a migration of a DU of the wireless network node from another BS (denoted as first BS) to the third BS, wherein an MT of the wireless network node has an RRC connection to yet another BS (denoted as second BS).

In operation 1613, the network node may receive a response in response to the request.

In some embodiments of the present disclosure, in the case that the response acknowledges the request, the wireless network node may: transmit, to the first BS, a message indicating F1 interface setup completion between the wireless network node and the third BS in response to the reception of the response. In some embodiments of the present disclosure, the message includes an identifier of the third BS.

In some embodiments of the present disclosure, the request includes an identifier of the first BS.

In some embodiments of the present disclosure, the wireless network node may transmit, to the second BS, an inquiry about whether there is an IP connection between the second BS and the third BS; and wherein the transmission of the request is based on a response to the inquiry from the second BS.

It should be appreciated by persons skilled in the art that the sequence of the operations in exemplary procedure 1600 may be changed and some of the operations in exemplary procedure 1600 may be eliminated or modified, without departing from the spirit and scope of the disclosure.

FIG. 17 illustrates a block diagram of exemplary apparatus 1700 according to some embodiments of the present disclosure.

As shown in FIG. 17, the apparatus 1700 may include at least one processor 1706 and at least one transceiver 1702 coupled to the processor 1706. The apparatus 1700 may be a network node (e.g., an IAB node), a BS (e.g., an IAB donor, IAB donor-CU, or IAB donor-DU), a DU of a BS, or a CU of a BS. In the case that apparatus 1700 is a BS, apparatus 1700 may further include a CU and at least one DU coupled to the CU. The CU and DU may be co-located or located separately. The CU and DU may be coupled to the processor 1706. In the case that apparatus 1700 is a network node, apparatus 1700 may further include an MT and a DU coupled to the MT. The MT and DU may be coupled to the processor 1706.

Although in this figure elements such as the at least one transceiver 1702 and processor 1706 are described in the singular, the plural is contemplated unless a limitation to the singular is explicitly stated. In some embodiments of the present application, the transceiver 1702 may be divided into two devices, such as a receiving circuitry and a transmitting circuitry. In some embodiments of the present application, the apparatus 1700 may further include an input device, a memory, and/or other components.

In some embodiments of the present application, the apparatus 1700 may be a BS. The processor 1706 may interact with other element(s) (e.g., transceiver 1702, a DU, or a CU) of the apparatus 1700 so as to perform the operations with respect to the BSs, the IAB donors, IAB donor-CUs, or IAB donor-DUs described in FIGS. 1-16. In some embodiments of the present application, the apparatus 1700 may be a network node. The transceiver 1702 and the processor 1706 may interact with each other so as to perform the operations with respect to the network nodes or the IAB nodes (mobile or stationary) described in FIGS. 1-16.

In some embodiments of the present application, the apparatus 1700 may further include at least one non-transitory computer-readable medium.

In some embodiments of the present disclosure, the non-transitory computer-readable medium may have stored thereon computer-executable instructions to cause the processor 1706 to implement the method with respect to the BSs, the IAB donors, IAB donor-CUs, or IAB donor-DUs as described above. For example, the computer-executable instructions, when executed, cause the processor 1706 interacting with, for example, transceiver 1702 to perform the operations with respect to the BSs, the IAB donors, IAB donor-CUs, or IAB donor-DUs described in FIGS. 1-16.

For example, in some embodiments of the present disclosure, the non-transitory computer-readable medium may have stored thereon computer-executable instructions to cause the processor 1706 to implement the method with respect to the network nodes or the IAB nodes (mobile or stationary) as described above. For example, the computer-executable instructions, when executed, cause the processor 1706 interacting with transceiver 1702 to perform the operations with respect to the network nodes or the IAB nodes (mobile or stationary) described in FIGS. 1-16.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “handover,” “path switch,” and “migration” may be used interchangeably. The terms “includes,” “including,” or any other variations thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A first base station (BS) for wireless communication, comprising:
at least one memory; and
at least one processor coupled with the at least one memory and configured to cause the first BS to:
determine whether there is an internet protocol (IP) connection between a second BS and a third BS, wherein one of the first BS and the second BS has a radio resource control (RRC) connection to a mobile termination (MT) of a wireless network node and the other one of the first BS and the second BS has an F1 connection to a distributed unit (DU) of the wireless network node; and
initiate, based on the determination, a migration of the MT of the wireless network node to the third BS or a migration of the DU of the wireless network node to the third BS.

2. The first BS of claim 1, wherein, to determine whether there is an IP connection between the second BS and the third BS, the at least one processor is configured to cause the first BS to:
initiate, to the second BS, the third BS, or both, an inquiry about whether there is an IP connection between the second BS and the third BS; and
determine whether there is an IP connection between the second BS and the third BS based on a response to the inquiry.

3. The first BS of claim 1, wherein the at least one processor is further configured to cause the first BS to receive, from the wireless network node or the second BS, location information of the MT of the wireless network node to assist the first BS to initiate the migration of the DU of the wireless network node.

4. The first BS of claim 1, wherein the at least one processor is further configured to cause the first BS to receive, from the second BS, first information regarding IP connectivity to the second BS; and
wherein the determination of whether there is an IP connection between the second BS and the third BS is based on the first information.

5. The first BS of claim 4, wherein the at least one processor is further configured to cause the first BS to transmit, to the second BS, second information regarding IP connectivity to the first BS; and
wherein the second information is transmitted in response to the reception of the first information or the first information is received in response to the transmission of the second information.

6. The first BS of claim 5, wherein the first information includes a first list of BSs and each BS in the first list of BSs has an IP connection to the second BS, and the second information includes a second list of BSs and each BS in the second list of BSs has an IP connection to the first BS.

7. A second base station (BS) for wireless communication, comprising:
at least one memory; and
at least one processor coupled with the at least one memory and configured to cause the second BS to:
receive, from a first BS, second information regarding internet protocol (IP) connectivity to the first BS, or an inquiry about IP connectivity of the second BS, wherein one of the first BS and the second BS has a radio resource control (RRC) connection to a mobile termination (MT) of a wireless network node and the other one of the first BS and the second BS has an F1 connection to a distributed unit (DU) of the wireless network node; and
transmit, to the first BS, first information regarding IP connectivity to the second BS.

8. The second BS of claim 7, wherein the first information is transmitted in response to the inquiry, wherein the inquiry is associated with an IP connection between the second BS and a third BS, and the first information indicates IP connectivity between the second BS and the third BS.

9. The second BS of claim 7, wherein the at least one processor is further configured to cause the second BS to, when the second BS has an RRC connection to the MT of the wireless network node, transmit location information of the MT of the wireless network node to the first BS.

10. The second BS of claim 7, wherein the first information is transmitted in response to the reception of the second information or the second information is received in response to the transmission of the first information.

11. A wireless network node for wireless communication, comprising:
at least one memory; and
at least one processor coupled with the at least one memory and configured to cause the wireless network node to:
transmit a request to a third base station (BS) to trigger a migration of a distributed unit (DU) of the wireless network node from a first BS to the third BS, wherein a mobile termination (MT) of the wireless network node has a radio resource control (RRC) connection to a second BS; and
receive a response in response to the request.

12. The wireless network node of claim 11, wherein, when the response acknowledges the request, the at least one processor is configured to cause the network node to:
transmit, to the first BS, a message indicating an F1 interface setup completion between the wireless network node and the third BS in response to the reception of the response.

13. The wireless network node of claim 12, wherein the message comprises an identifier of the third BS.

14. The wireless network node of claim 11, wherein the request comprises an identifier of the first BS.

15. The wireless network node of claim 11, wherein the at least one processor is further configured to cause the wireless network node to transmit, to the second BS, an inquiry about whether there is an internet protocol (IP) connection between the second BS and the third BS; and wherein the transmission of the request is based on a response to the inquiry from the second BS.

16. A method performed by a wireless network node, the method comprising:
transmitting a request to a third base station (BS) to trigger a migration of a distributed unit (DU) of the wireless network node from a first BS to the third BS, wherein a mobile termination (MT) of the wireless network node has a radio resource control (RRC) connection to a second BS; and
receiving a response in response to the request.

17. The method of claim 16, wherein, when the response acknowledges the request, the method further comprises:
transmitting, to the first BS, a message indicating an F1 interface setup completion between the wireless network node and the third BS in response to the reception of the response.

18. The method of claim 17, wherein the message comprises an identifier of the third BS.

19. The method of claim 17, wherein the request comprises an identifier of the first BS.

20. The method of claim 16, further comprising: transmitting, to the second BS, an inquiry about whether there is an internet protocol (IP) connection between the second BS and the third BS; and wherein the transmission of the request is based on a response to the inquiry from the second BS.
